(19) United States
(12) Patent Application Publication
(10) Pub. No.: US 2021/0185405 A1
(43) Pub. Date: Jun. 17, 2021

(54) PROVIDING ENHANCED CONTENT WITH IDENTIFIED COMPLEX CONTENT SEGMENTS

(71) Applicant: Rovi Guides, Inc., San Jose, CA (US)

(72) Inventors: Vishwas Sharadanagar Panchaksharaiah, Tumkur District (IN); Vikram Makam Gupta, Bangalore (IN)

(21) Appl. No.: 16/717,214

(22) Filed: Dec. 17, 2019

(51) Int. Cl. H04N 21/488; H04N 21/81; H04N 21/845; H04N 21/6587

(52) U.S. Cl. CPC H04N 21/4884; H04N 21/4888; H04N 21/6587; H04N 21/845; H04N 21/8133

(57) ABSTRACT

Methods and systems are described for learning which content segments may be complex and providing enhanced content with playback of those complex segments. A complexity engine accesses content, the content includes a plurality of ordered segments and each of the plurality of segments associated with a complexity score. The complexity engine provides each of the plurality of ordered segments of the content for consumption. After receiving input that identifies a first segment of the plurality of segments as complex, the complexity engine calculates a comprehension threshold based on the complexity score associated with the first segment. While further providing content segments, the complexity engine identifies a subsequent segment where the complexity score is greater than or equal to the comprehension threshold. The complexity engine provides corresponding enhanced content with the subsequent segment.

### BACKGROUND

The present disclosure relates to systems for providing content, and more particularly to systems and related processes for identifying complex segments in content and providing enhanced content with subsequent complex segments.

### SUMMARY

Devices may be designed to facilitate delivery of content for consumption. Content like video, animation, music, audiobooks, ebooks, playlists, podcasts, images, slideshows, games, text, and other media may be consumed by users at any time, as well as nearly in any place.

Abilities of devices to provide content to a content consumer are often enhanced with the utilization of advanced hardware with increased memory and fast processors in devices. Devices—e.g., computers, telephones, smartphones, tablets, smartwatches, microphones (e.g., with a virtual assistant), activity trackers, e-readers, voice-controlled devices, servers, televisions, digital content systems, video game consoles, and other internet-enabled appliances—can provide and deliver content almost instantly.

Interactive content guidance applications may take various forms, such as interactive television program guides, electronic program guides and/or user interfaces, which may allow users to navigate among and locate many types of content including conventional television programming (provided via broadcast, cable, fiber optics, satellite, internet (IPTV), or other means) and recorded programs (e.g., DVRs) as well as pay-per-view programs, on-demand programs (e.g., video-on-demand systems), internet content (e.g., streaming media, downloadable content, webcasts, shared social media content, etc.), music, audiobooks, websites, animations, podcasts, (video) blogs, ebooks, and/or other types of media and content.

The interactive guidance provided may be for content available through a television, or through one or more devices, or bring together content available both through a television and through internet-connected devices using interactive guidance. The content guidance applications may be provided as online applications (e.g., provided on a website), or as stand-alone applications or clients on handheld computers, mobile telephones, or other mobile devices. Various devices and platforms that may implement content guidance applications are described in more detail below.

Media devices, content delivery systems, and interactive content guidance applications may utilize input from various sources including remote controls, keyboards, microphones, video and motion capture, touchscreens, and others. For instance, a remote control may use a Bluetooth connection to a television or set-top box to transmit signals to move a cursor. A connected keyboard or other device may transmit input data, via, e.g., infrared or Bluetooth, to a television or set-top box. A remote control may transmit voice data, captured by a microphone, to a television or set-top box. Voice recognition systems and virtual assistants connected with televisions or devices may be used to search for and/or control playback of content to be consumed. Finding, selecting, and presenting content is not necessarily the end of providing content for consumption by an audience. Controlling playback should be accessible and straightforward.

Trick-play (or trick mode) is a feature set for digital content systems, such as DVR or VOD, to facilitate time manipulation of content playback with concepts like pause, fast-forward, rewind, and other playback adjustments and speed changes. Trick-play features typically function with interactive content guidance applications or other user interfaces. Some content playback systems utilize metadata that may divide content into tracks or chapters to perform a “next-track” or “previous-track” at a push of a button. Some content playback systems mimic functions of analogue systems and play snippets or images while “fast-forwarding” or “rewinding” digital content. Along with fast-forward at multiple, various speeds, systems may include a “skip-ahead” function to jump ahead, e.g., 10, 15, or 30 seconds, in content to allow skipping of a commercial or redundant content. Along with rewind at multiple, various speeds, systems may include a “go-back” or “replay” function that would skip backwards, e.g., 10, 15, or 30 seconds, in content to allow a replay.

Manipulating playback of content may be caused by input based on remote control, mouse, touch, gesture, voice or various other input. Performing trick-play functions has traditionally been via remote control—e.g., a signal caused by a button-press of a remote control. Functions may be performed via manipulation of a touchscreen, such as adjustment of a slider bar to affect playback time and enable replay or skip-ahead functions. Voice recognition systems and connected virtual assistants may allow other playback functions as such systems may not be limited. For instance, some systems may adjust playback of a content item by a precise time when a voice assistant is asked to “replay the last 52 seconds” or “go back 94 seconds.” As input mechanisms grow more sophisticated and allow additional input, playback and trick-play functions should evolve.

As content is consumed it may not always be understood by a consumer. For instance, a scene from a film may be confusing, a segment from a news program may be complicated, or a chapter of an audiobook may not be clear. Content substance may be confusing in itself, such as use of flashbacks or an unconventional timeline. Content substance may use different languages. Content substance may present difficult or complex topics, such as science, politics, medicine, legal procedure, fantasy, science fiction, economics, sports, or pop culture from an unfamiliar era. A confused audience or disorganized content creator may be partially to blame, but presentation of content may be a contributing factor to audience misunderstandings.

Content delivery systems and interactive program interfaces should simplify and maximize the viewing experience. For instance, when substance of a delivered program is not properly comprehended by a content consumer, content delivery systems must do more to present content in a way to be consumed and comprehended—merely rewinding or replaying a complex program segment may be insufficient. User interfaces can learn when an audience finds a scene complex, anticipate subsequent complex scenes in content, and deliver enhanced content along with complex content segments.

Accessibility is a practice of making interfaces usable by as many people as possible. For instance, accessible designs and development may allow use by those with disabilities and/or special needs. When content itself may not be accessible to all, interfaces may be able to improve content consumption. While content producers likely take care in making content accessible by all, a content delivery system and content playback interface may be able to do more to make content accessible and comprehensible by more.

For instance, presentation issues may diminish content understandability even when distinct from complexities within content substance. Content segments may be presented with audio issues, such as quiet dialogue or competing loud noises, that may make scenes difficult to comprehend. Content may be presented discolored, dark, or with unclear images. Content may be played back at too fast a speed for certain users. Content may be poorly adapted for a different medium or presentation mode, such as originally produced for 3-D or large-format screen. Content may have a combination of issues when presented.

To address complexity issues in content, content delivery systems and interactive guidance applications may identify content confusing to an audience and present additional clarifying content. Enhanced content should add to the comprehensibility of content. Enhanced content may be any type of content and/or alteration to content that may make content less complex and more easily understood. For instance, a complexity engine may identify that content dialogue is complex and provide enhanced content of boosting dialogue audio, showing captions, or otherwise including extra description or information. A complexity engine may provide a written description. A complexity engine may determine that the timeline is difficult and edit the order of playback for certain scenes. A complexity engine may improve picture brightness if image issues are identified as a cause for comprehension issues. Enhanced content may be associated with content via metadata or accessed by a complexity engine separately.

Moreover, a whole program or film may not be problematic, as only one or a few segments of content may be too complex. A complexity score associated with each segment may be used to measure the complexity of a scene or segment. Some embodiments may use complexity scores to compare the complexity of corresponding segments within one or more content items. For instance, a complexity score may be measured as a numeric score such as a such as a number from 0 to 100, a decimal from 0 to 1, a letter grade, a word description (e.g., “low” to “high”), or one of any other ratings scales. Complexity scores may be normalized for a program, series, season, playlist, genre, or other collection of content. Complexity scores may be a ranking of a scene in relation to other scenes within a program. Complexity scores may be dynamically calculated based on live or recent feedback from current viewers as aggregated via network. Complexity scores may be adjusted as new content is added or released. In some embodiments, complexity scores may be stored as content metadata and associated with content segments. In some embodiments, complexity scores may be stored in a complexity score database and associated with content items and content segments.

Each segment of content may have a complexity score, as well as other metadata that may identify genre, characters, themes, etc., in order to identify scenes or segments that may be perceived as complex. Complexity scores of each segment may be used to identify segments a content consumer may find complex. Once a content consumer identifies a scene as complex, scenes with a higher complexity score may be played with enhanced content automatically.

For instance, in some embodiments, a device using a complexity engine may be playing-back a program with a number of scenes. Each scene of the program is associated with a complexity score and a scene number. As the program progresses, input may be provided to indicate a scene was complex or difficult to understand. This input might be a remote-control command to rewind or replay, or it might be a voice command. The complexity engine marks the scene as complex and records the associated complexity score as a comprehension threshold, which may be altered or weighted based on profile data. When a first scene is identified as complex, the device can provide enhanced content with a replay that scene. As subsequent scenes are played back, if the respective complexity score of the scene is greater than or equal to the comprehension threshold, then the complexity engine automatically provides enhanced content with the subsequent complex scenes. The complexity engine effectively learns which content segments a content consumer may find complex and provides enhanced content on first playback.

Once a comprehension threshold is calculated, a complexity engine may provide enhanced content for segments with complexity scores in other programs. For instance, when streaming television programming or consuming on-demand content, if a segment in an episode is marked as complex, then enhanced content may be automatically played with a scene in a later episode of that television series if that segment has a higher complexity score associated with it. Moreover, when consuming different television shows, films, or series, if a segment in an episode of a first program is marked as complex, then enhanced content may be automatically played with a scene from an unrelated television program if that segment has a higher complexity score associated with it. The complexity engine may develop a profile to identify a threshold and automatically provide enhanced content when providing segments associated with complexity scores higher than the threshold. The complexity engine may develop a profile to identify multiple thresholds.

A complexity engine may ask for more details to generate a complexity profile. A content consumer may find certain genres and topics more complex. For instance, a content consumer may find legal dramas more complex than content with science fiction/fantasy. A complexity profile may include a rating for preferences of content genres to facilitate calculation of different thresholds for each genre. For instance, a content consumer may have a threshold of 75 (e.g., on a 0-100 scale) for scenes related to medicine but may have a threshold of only 55 for segments related to politics. In such a situation, enhanced content would be presented more often with segments related to politics than with segments related to medicine.

The complexity scores for each segment, and identification of genres, may be established in many ways. For instance, content producers may identify a complexity score and/or associated genres/topics for each scene of the content. Content delivery systems, content providers, or third-party critics may also identify a complexity score and/or associated genres/topics for each scene of the content. For instance, in some embodiments, a complexity score, as determined by a producer and may be stored as metadata for each scene of a film. Each scene may be given a score of 1-100 to identify how complex a viewer may find it. The Content delivery systems may solicit feedback from content consumers in order to identify a complexity score and/or associated genres/topics for each scene of the content. Feedback via social networking may generate data on content complexity and complexity scores evolve over time. Social media users may identify complex content as well as complex segments. Feedback may come directly from a social network. For instance, certain scenes may be the subject of discussion on social media. In some embodiments, multiple comments on a posted clip may indicate a higher complexity score. In some embodiments, likes or dislikes may identify complex scenes. Likewise, social media commentary could be used as enhanced content to help comprehension.

Feedback may be solicited by the content delivery system, effectively creating a social network. For instance, a system may ask questions (e.g., trivia) after a segment is viewed to gauge whether a viewer understood the scene. That system may ask hundreds of viewers the same question and determine a complexity score based on a percentage of correct answers (and/or the percentages for each incorrect answer). Collection of feedback and data, in addition to ratings by content producers, critics or others, may improve identification of complex segments and help the complexity engine identify complex segments and automatically provide enhanced content before receiving input. A system may be able to match a viewer profile within the user network to aid in identifying viewed scenes likely to be found complex by another similar viewer profile. Feedback data on comprehension of segments of content allow the system to learn which scenes are complex and aid in presenting enhanced content to reduce complexity of future content segments.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 depicts illustrative scenarios and user interfaces for identifying a complex segment and providing enhanced content, in accordance with some embodiments of the disclosure;

FIG. 2 depicts illustrative scenarios and user interfaces for identifying a complex segment and providing enhanced content, in accordance with some embodiments of the disclosure;

FIG. 3A depicts an illustrative scenario and user interface for identifying a complex segment to provide enhanced content, in accordance with some embodiments of the disclosure;

FIG. 3B depicts an illustrative scenario and user interface for identifying a complex segment to provide enhanced content, in accordance with some embodiments of the disclosure;

FIG. 4A depicts an illustrative scenario and user interface for identifying a complex segment to provide enhanced content, in accordance with some embodiments of the disclosure;

FIG. 4B depicts an illustrative scenario and user interface for identifying a complex segment to provide enhanced content, in accordance with some embodiments of the disclosure;

FIG. 5 depicts an illustrative scenario and user interface for a profile of complex segments and enhanced content, in accordance with some embodiments of the disclosure;

FIG. 6 depicts an illustrative flowchart of a process for identifying a complex segment to provide enhanced content, in accordance with some embodiments of the disclosure;

FIG. 7 is a diagram of an illustrative device, in accordance with some embodiments of the disclosure; and

FIG. 8 is a diagram of an illustrative system, in accordance with some embodiments of the disclosure.

### DETAILED DESCRIPTION

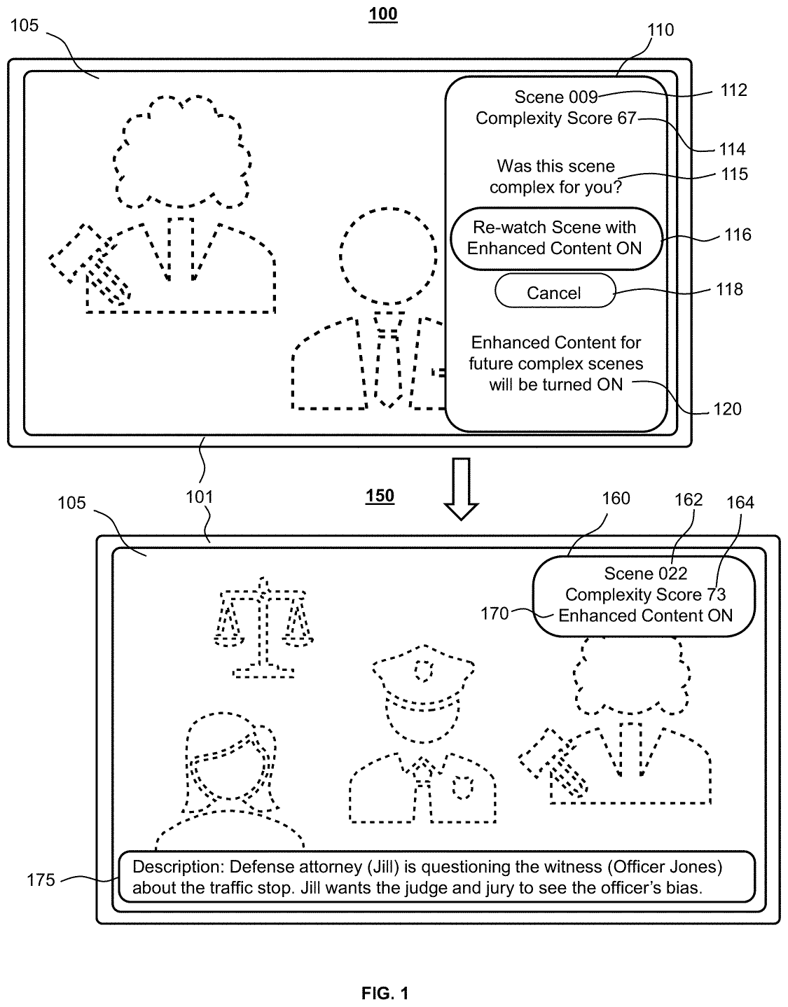

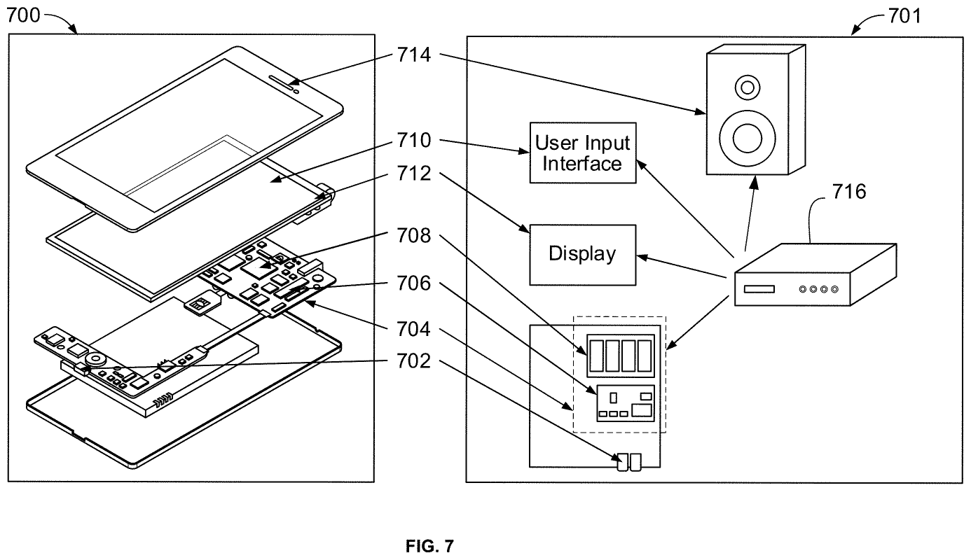

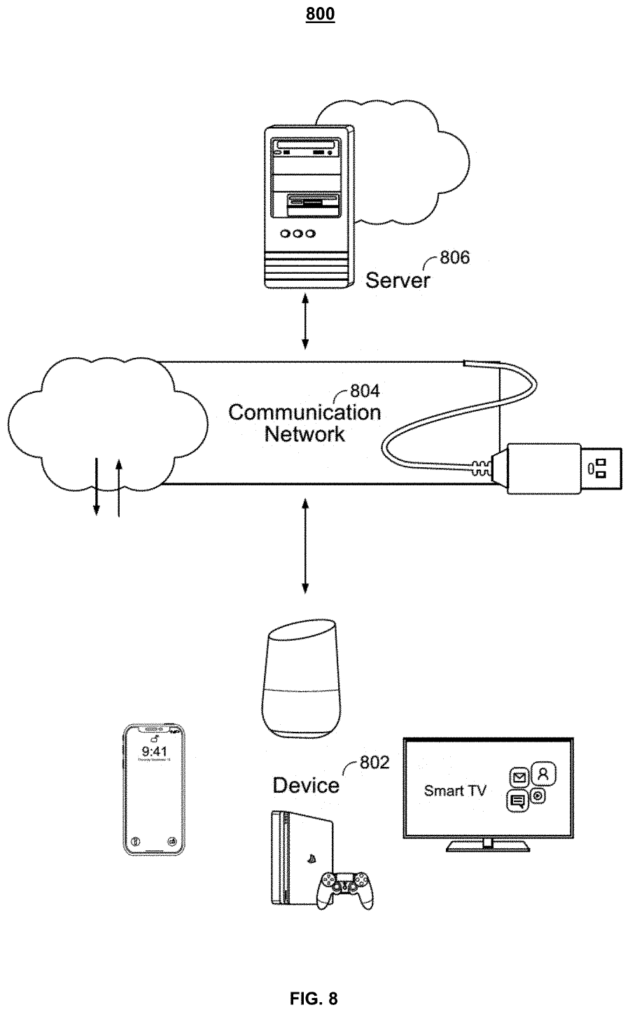

FIG. 1 depicts illustrative scenarios 100 and 150 and user interface 105 for identifying a complex segment and providing enhanced content, in accordance with some embodiments of the disclosure. Scenario 100 of FIG. 1 illustrates a content delivery system featuring a graphical user interface, e.g., user interface 105, depicting a scene from a program with interactivity regarding how complex the scene may be. As shown, device 101 generates user interface 105. Device 101 may be any suitable device such as a television, personal computer, laptop, smartphone, tablet, media center, video console, or any device as depicted in FIGS. 7 and 8, with the combination of devices having capabilities to receive input and provide content for consumption. Input for device 101 may be any suitable input interface such as a touchscreen, touchpad, or stylus and/or may be responsive to external device add-ons, such as a remote control, mouse, trackball, keypad, keyboard, joystick, voice recognition interface, or other user input interfaces. Some embodiments may utilize a complexity engine, e.g., as part of an interactive content guidance application, stored and executed by one or more of the processors and memory of device 101 to receive input, record complexity scores of complex scenes, calculate comprehension threshold, and identify other complex scenes.

In scenario 100, user interface 105 includes a depiction of a provided program along with interactivity options. User interface 105 may include an overlay, such as complexity interface 110 as depicted in scenario 100. Appearance of complexity interface 110 may occur as a result of input indicating a scene or segment was complex or needs to be re-watched. For instance, complexity interface 110 may appear as a result of a rewind or replay command. A device may receive a “go back 30 seconds” command, and complexity interface 110 may pop up. In some embodiments, complexity interface 110 may appear as a result of input such as a menu request or other remote-control command. A user may input a directional arrow command to trigger complexity interface 110 to pop up. A user may input a pause command to trigger complexity interface 110 to pop up. In some embodiments, complexity interface 110 may appear as a result of a voice command, indicating confusion or a lack of understanding. For instance, a viewer may say, “I didn't understand that scene,” “That was confusing,” or “What happened?” and user interface may freeze and present complexity interface 110. In some embodiments, complexity interface 110 may appear automatically and/or based on preference settings. For instance, as further discussed below, a complexity engine may determine that when a scene has a complexity score greater than a complexity threshold that was, e.g., saved in a profile, a complexity interface 110 should appear.

In some embodiments, like any overlay in a user interface, complexity interface 110 may appear momentarily and disappear. Complexity interface 110 may, for example, appear as overlaying a screen while a scene is paused. Complexity interface 110 is depicted in FIG. 1 to illustrate details of a potential embodiment, and some information included with complexity interface 110 in FIG. 1 may not be provided to a content consumer.

In some embodiments, such as depicted in scenario 100, complexity interface 110 may include a scene identification 112 and a scene complexity score 114. In scenario 100, for example, scene identification 112 indicates that “Scene 009” is depicted. In some embodiments, scenes or segments of a program may be identified by sequence numbers or other identification. In some embodiments, scene identification 112 may include program, episode, series, or other segment or scene identifying information.

Each scene or segment identified by a scene identification 112 may have an associated scene complexity score 114. In scenario 100, for example, scene complexity score 114 indicates that a scene (e.g., “Scene 009”) has a complexity score of 67. Some embodiments may use complexity scores to compare the complexity of corresponding segments within one or more content items. Complexity scores may, for instance, be measured as a numeric score such as a number from 0 to 100, a decimal from 0 to 1, a letter grade, a word description (e.g., “low” to “high”), or one of any other ratings scales. Complexity scores may be normalized.

In scenario 100, along with scene identification 112 and complexity score 114, complexity interface 110 includes prompt 115. In some embodiments, a complexity interface may ask a viewer, “Was this scene complex for you?” and present one or more options to select. In scenario 100, options include re-watch button 116 and cancel button 118.

In some embodiments, a scene may be re-watched or replayed with enhanced content and following scenes with complexity scores that are, e.g., equal to or higher would be played with associated enhanced content. In scenario 100, selecting re-watch button 116 would replay the scene (scene identification 112) and turn on an enhanced content feature. Depicted in complexity interface 110 is enhanced content configuration 120. In scenario 100, enhanced content configuration 120 indicates that “Enhanced Content for future complex scenes will be turned ON.” For example, enhanced content configuration 120 may be activated and user interface 105 would provide enhanced content for future scenes of content with a complexity score that is greater than or equal to the value indicated by complexity score 114. Scenario 150 of FIG. 1 illustrates an embodiment resulting from activation of enhanced content configuration 120 by, e.g., selection of re-watch button 116. In scenario 100, selecting cancel button 118 would, e.g., cancel a replay and initiate playback of the next scene or segment. If cancel is chosen in scenario 100, for example, then enhanced content for future scenes would not be turned on.

In some embodiments, selection of a menu button, e.g., re-watch button 116 or cancel button 118, may be received as input, for example via remote or voice control. In some embodiments, selection may be default and selected automatically. In some embodiments, content could pause momentarily, e.g., waiting for input to contradict replaying the scene, and then replay the scene without further input. Such a momentary pause, e.g., a time-out, may include a countdown clock. For instance, upon activation complexity interface 110 could present prompt 115 and wait for a time-out prior to re-watching the scene in question. Similarly, complexity interface 110 could wait for a time-out prior to automatically selecting cancel button 118.

In some embodiments, selection of re-watch button 116 may cause recordation of the corresponding complexity score 114, as well as scene identification 112 and other metadata. Complexity score 114 may be recorded in a complexity database and used to calculate complexity scores. Complexity score 114 may be recorded in a viewer profile, locally and/or remotely. Recording complexity score 114 may establish a threshold to identify segments in the content (and in other content) that may be complex. For instance, if a subsequent scene has a complexity score higher than the recorded complexity score 114, enhanced content may be automatically provided with that scene. In some embodiments, complexity score 114 may be calculated or adjusted based on multiple viewers each selecting re-watch button 116, respectively.

Scenario 150 depicts an embodiment user interface 105 including a depiction of a provided program along with enhanced content after activation of enhanced content configuration 120 by, e.g., selection of re-watch button 116. In some embodiments, such as depicted in scenario 150, complexity interface 160 may include a scene identification 162 and a scene complexity score 164. In scenario 150, for example, scene identification 162 indicates that “Scene 022” is depicted. In FIG. 1, scenario 150 occurs after scenario 100 and “Scene 022,” indicated by scene identification 162, would follow “Scene 009” as indicated by scene identification 112.

In some embodiments, enhanced content may be depicted as a text description when enhanced content configuration is activated. For example, user interface 105 includes enhanced content 175 with depiction of the program to further describe a scene. In some embodiments, enhanced content 175 may be an additional description. For instance, in scenario 150, enhanced content 175 includes a text description of the scene, which may help comprehension. In scenario 150, activation of enhanced content is indicated by enhanced content configuration 170 and enhanced content 175 is provided. In scenario 150, a segment identified by scene identification 162 as “Scene 022” is depicted with enhanced content 170.

In some embodiments, enhanced content is provided only for scenes with complexity scores greater than or equal to a complexity score of the scene where enhanced content configuration was activated. Scenario 150, for example, depicts a scene with a complexity score greater than the complexity score of the scene in scenario 100. That is, in scenario 150, because complexity score 164 has a value of 73 for “Scene 022” and enhanced content configuration 170 was activated earlier with “Scene 009,” which had a complexity score of 67, enhanced content 175 is provided with the content.

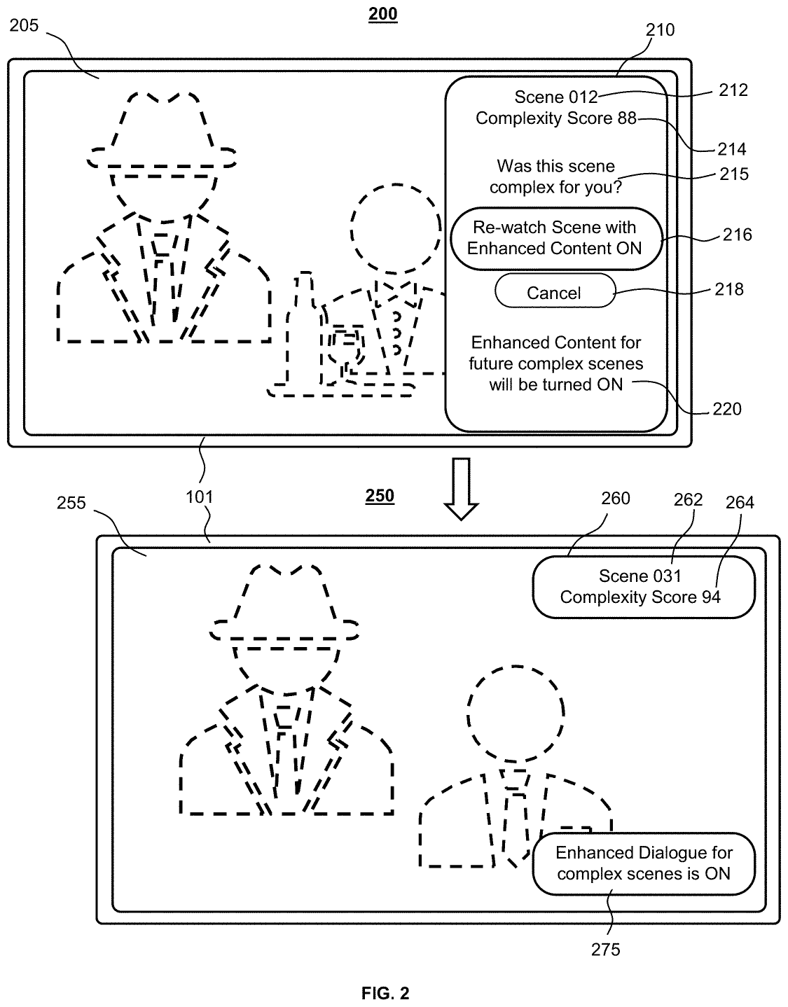

FIG. 2 depicts illustrative scenarios 200 and 250 and user interface 205 for identifying a complex segment and providing enhanced content, in accordance with some embodiments of the disclosure. Scenario 200 of FIG. 2 illustrates a content delivery system featuring a graphical user interface, e.g., user interface 205, depicting a scene from a program with interactivity regarding how complex the scene may be. As shown, device 101 generates user interface 205.

In scenario 200, user interface 205 includes a depiction of a provided program along with interactivity options. User interface 205 may include an overlay, such as complexity interface 210 as depicted in scenario 200. Appearance of complexity interface 210 may occur as a result of input indicating a scene or segment was complex or needs to be re-watched. For instance, complexity interface 210 may appear as a result of a rewind or replay command. A user may input a “go back 30 seconds” command, and complexity interface 210 may pop up. In some embodiments, complexity interface 210 may appear as a result of input such as a menu request or other remote-control command such as pressing of a replay button or a voice command, indicating lack of comprehension. In some embodiments, complexity interface 210 may appear automatically and/or based on preference settings.

In some embodiments, such as depicted in scenario 200, complexity interface 210 may include a scene identification 212 and a scene complexity score 214. In scenario 200, for example, scene identification 212 indicates that “Scene 012” is depicted.

Each scene or segment identified by a scene identification 212 may have an associated scene complexity score 214. In scenario 200, for example, scene complexity score 214 indicates that a scene (e.g., “Scene 012”) has a complexity score of 88. Some embodiments may use complexity scores to compare the complexity of corresponding segments within one or more content items.

In scenario 200, complexity interface 210 includes prompt 215. In some embodiments, a complexity interface may ask, “Was this scene complex for you?” and present one or more options to select. In scenario 200, options include re-watch button 216 and cancel button 218.

In some embodiments, a scene may be re-watched or replayed with enhanced content and any following scenes with complexity scores that are, e.g., equal to or higher would be played with associated enhanced content. In scenario 200, selecting re-watch button 216 would replay the scene (scene identification 212) and turn on an enhanced content feature. Depicted in complexity interface 210 is enhanced content configuration 220. In scenario 200, enhanced content configuration 220 indicates that “Enhanced Content for future complex scenes will be turned ON.” For example, enhanced content configuration 220 may be activated, and user interface 205 would provide enhanced content for future scenes of content with a complexity score that is greater than or equal to the value indicated by complexity score 214. Scenario 250 of FIG. 2 illustrates an embodiment resulting from activation of enhanced content configuration 220 by, e.g., selection of re-watch button 216. In scenario 200, selecting cancel button 218 would, e.g., cancel a replay and initiate playback of the next scene or segment.

In some embodiments, selection of a menu button, e.g., re-watch button 216 or cancel button 218, may be received as input, for example via remote or voice control. In some embodiments, selection may be default and selected automatically, e.g., after a time-out.

Scenario 250 depicts an embodiment user interface 205 including a depiction of a provided program along with enhanced content after activation of enhanced content configuration 220 by, e.g., selection of re-watch button 216. In some embodiments, such as depicted in scenario 250, complexity interface 260 may include a scene identification 262 and a scene complexity score 264. In scenario 250, for example, scene identification 262 indicates that “Scene 031” is depicted. In FIG. 2, scenario 250 occurs after scenario 200 and “Scene 031,” indicated by scene identification 262, would follow “Scene 012” as indicated by scene identification 212.

In some embodiments, enhanced content may include enhanced dialogue, e.g., when enhanced content configuration is activated. For example, user interface 255 includes enhanced dialogue indicator 275. Like complexity interface 260, enhanced dialogue indicator 275 may appear momentarily or for entire durations of more complex scenes. In scenario 250, a segment identified by scene identification 262 as “Scene 031” is depicted with enhanced dialogue indicator 275. Enhanced dialogue may be any form of enhancing dialogue to aid in understanding by viewers. In some embodiments, enhanced content, as identified by enhanced dialogue indicator 275, may be dialogue that is played at a louder volume or with lower background noises, to clarify the volume. Enhanced dialogue may include, for example, with digital signal processing or analysis of multiple audio tracks provided with multimedia to identify and enhance voices. Enhanced dialogue may include additional or alternative dialogue. For instance, if dialogue uses unfamiliar and/or multiple languages, enhanced dialogue could include audio with a translation. If dialogue uses technical jargon or particular terminology, enhanced dialogue may be used, e.g., to substitute words or explain vocabulary.

In some embodiments, enhanced content is provided only for scenes with complexity scores greater than or equal to a complexity score of the scene where enhanced content configuration was activated. Scenario 250, for example, depicts a scene with a complexity score greater than the complexity score of the scene in scenario 200. That is, in scenario 250, because complexity score 264 has a value of 94 for “Scene 031” and enhanced dialogue indicator 275 was activated earlier with “Scene 012,” which had a complexity score of 88, enhanced content is provided with the content.

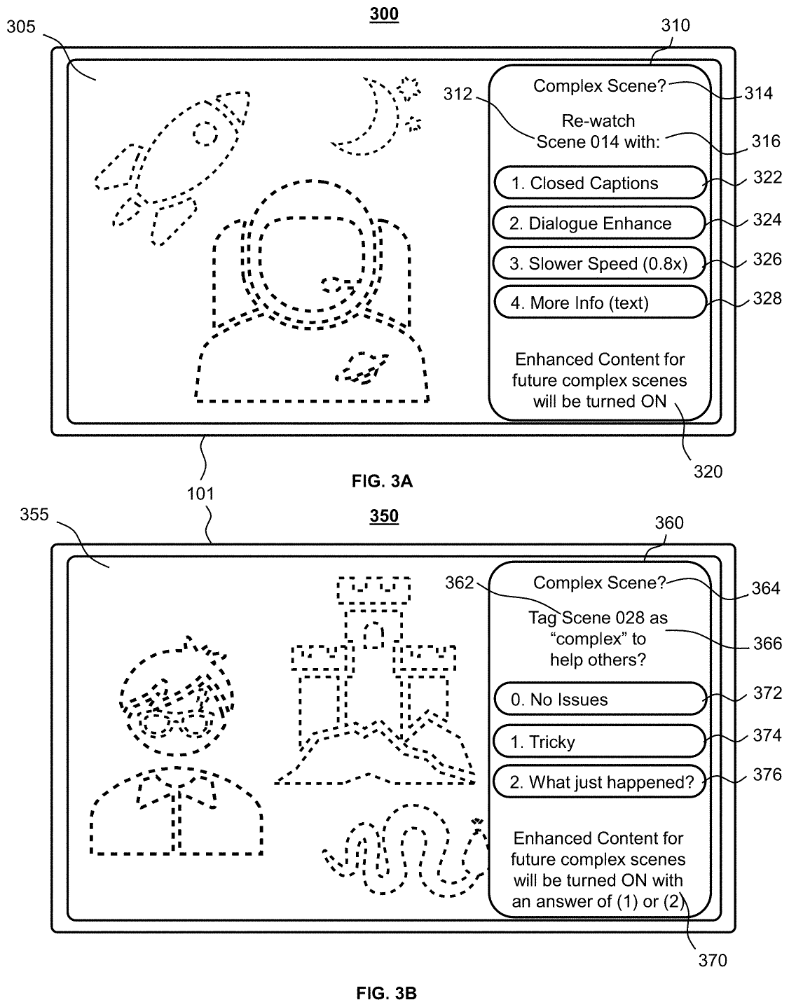

FIG. 3A depicts illustrative scenario 300 and user interface 305 for identifying a complex segment and providing enhanced content, in accordance with some embodiments of the disclosure. Scenario 300 of FIG. 3A illustrates a content delivery system featuring a graphical user interface, e.g., user interface 305, depicting a scene from a program with interactivity regarding how complex the scene may be. As shown, device 101 generates user interface 305.

In scenario 300, user interface 305 includes a depiction of a provided program along with interactivity options. User interface 305 may include an overlay, such as complexity interface 310 as depicted in scenario 300. Appearance of complexity interface 310 may occur as a result of input indicating a scene or segment was complex or needs to be re-watched. For instance, complexity interface 310 may appear as a result of a rewind or replay command. A user may input a “go back 30 seconds” command, and complexity interface 310 may pop up. In some embodiments, complexity interface 310 may appear as a result of input such as a menu request or other remote-control command such as pressing of a replay button or a voice command, indicating lack of comprehension. In some embodiments, complexity interface 310 may appear automatically and/or based on preference settings.

In some embodiments, such as depicted in scenario 300, complexity interface 310 may include a scene identification 312. In scenario 300, for example, scene identification 312 indicates that “Scene 014” is depicted.

In scenario 300, complexity interface 310 includes label 314 and re-watch prompt 316. In some embodiments, a complexity interface may ask, “Complex Scene?” or “Was this scene complex for you?” In scenario 300, re-watch prompt 316 is depicted along with several options available for selection. For instance, complexity interface 310 may include closed-captions button 322, dialogue enhance button 324, slower speed button 326, and/or more info button 328. In some embodiments, each button may trigger playback of enhanced content along with playback of the prior scene. In some embodiments, each button may be selected so that multiple forms of enhanced content may be included along with playback of the prior scene.

In scenario 300, complexity interface 310 includes closed-captions button 322. In scenario 300, selecting closed-captions button 322 would, e.g., replay the scene identified by scene identification 312 and turn on an enhanced content feature that included closed-captions or other dialogue text.

Some embodiments may include a dialogue enhance button 324. For instance, in scenario 300, complexity interface 310 includes dialogue enhance button 324. In scenario 300, selecting dialogue enhance button 324 would, e.g., replay the scene and turn on an enhanced content feature that included enhanced dialogue. Enhanced content associated with selecting a dialogue enhance button 324 may include, for example, digital signal processing or analysis of multiple audio tracks provided with multimedia. Enhanced dialogue may include additional or alternative dialogue.

Some embodiments may include a slower speed button 326. For instance, in scenario 300, selecting slower speed button 326 would, e.g., replay the scene at a slower speed, such as eight-tenths (0.8×) of normal speed (1.0×). Playing a scene more slowly may allow better comprehension.

In scenario 300, complexity interface 310 includes more info button 328. In scenario 300, selecting more info button 328 would, e.g., replay the scene and turn on an enhanced content feature that included additional description or other text. Additional description may include, e.g., a text description of the scene that may aid in comprehension. For example, scenario 150 of FIG. 1 illustrates an embodiment with additional description as enhanced content 175.

Depicted in complexity interface 310 is enhanced content configuration 320. In scenario 300, enhanced content configuration 320 indicates that “Enhanced Content for future complex scenes will be turned ON.” For example, enhanced content may be activated by selecting one or more options of complexity interface 310 such as closed-captions button 322, dialogue enhance button 324, slower speed button 326, and/or more info button 328, and user interface 305 would provide enhanced content for future scenes of content with a complexity score that is greater than or equal to a complexity score associated with the scene identified by scene identification 312.

An exemplary embodiment is depicted in FIG. 3B as scenario 350 with device 101 generating user interface 355. Scenario 350 of FIG. 3B illustrates an embodiment of a content delivery system featuring a graphical user interface, e.g., user interface 355, produced by device 101, depicting a scene from a program with interactivity regarding how complex the scene may be. User interface 355 of scenario 350 may be provided to, e.g., specific users, random users, or all users, so that a complexity engine may solicit and receive data regarding complexity of various content segments. A complexity engine may record results of solicitation, such as depicted in scenario 350, so as to generate and/or adjust complexity scores for content segments.

Scenario 350, for example, solicits feedback as to whether a scene is complex or not complex in order to tag a scene and collect data regarding scene complexity. In scenario 350, user interface 355 includes a depiction of a provided program along with interactivity options. User interface 355 may include an overlay, such as complexity interface 360 as depicted in scenario 350. In scenario 350, complexity interface 360 appears in user interface 355 after a content segment was provided to request feedback regarding complexity.

Appearance of complexity interface 360 may occur automatically or as a result of input indicating a scene or segment was complex or needs to be re-watched. For instance, complexity interface 360 may appear as a result of a rewind or replay command. A user may input a “go back 30 seconds” command, and complexity interface 360 may pop up. In some embodiments, complexity interface 360 may appear as a result of input such as a menu request or other remote-control command such as pressing of a replay button or a voice command, indicating lack of comprehension. In some embodiments, complexity interface 360 may appear automatically and/or based on preference settings. For instance, complexity interface 360 may appear to request feedback about a particular content segment because the content segment may be new and/or lack sufficient data for a complexity engine to determine a complexity score.

In some embodiments, such as depicted in scenario 350, complexity interface 360 may include a scene identification 362. In scenario 350, for example, scene identification 362 indicates that “Scene 028” is depicted.

In scenario 350, complexity interface 360 includes label 364 and complexity tag prompt 366. In some embodiments, a complexity interface may ask, “Complex Scene?” or “Was this scene complex for you?” In scenario 350, complexity tag prompt 366 is depicted along with several options available for selection. Complexity tag prompt 366 of scenario 350, for example, solicits feedback as to whether a scene is complex or not complex in order to tag a scene and collect data. Complexity interface 360 may include options such as response buttons 372, 374, and/or 376. For instance, scenario 350 includes complexity tag prompt 366 requesting to “Tag Scene 028 as ‘complex’ to help others?” and offers responses as response button 372 (“0. No Issues”), response button 374 (“1. Tricky”), and response button 376 (“What just happened?”).

In some embodiments, response options may be different. For instance, response buttons 372, 374, and/or 376 may be expanded to five choices, e.g., representing a scale of 0 to 4. In some embodiments, response options may include a numeric scale of 0 to 99. In some embodiments, response options may include voice or audio feedback. In some embodiments, response options may include comparisons to one or more other content segments.

In some embodiments, responses to complexity tag prompt 366, such as selections of response buttons 372, 374, and/or 376 may cause recordation of the corresponding complexity score, as well as scene identification 362 and other metadata. Complexity score may be recorded in a complexity database and used to calculate complexity scores. The corresponding complexity score may be recorded in a viewer profile, locally and/or remotely. Recording a complexity score may establish a threshold to identify segments in the content (and in other content) that may be complex. For instance, if a subsequent scene has a complexity score higher than the recorded complexity score, enhanced content may be automatically provided with that scene. In some embodiments, complexity score may be calculated or adjusted based on multiple viewers each selecting response buttons 372, 374, and/or 376, respectively. Complexity scores may be calculated using various statistical analyses. Complexity scores associated with the content segment may be adjusted based on recorded responses. Complexity scores associated with other content segments may be adjusted based on comparisons.

In some embodiments, selecting one or more responses to complexity tag prompt 366, such as selections of response buttons 372, 374, and/or 376, may trigger playback of enhanced content along with playback of the prior scene. For instance, selecting response button 374 and/or response button 376 may indicate a lack of understanding and/or a need to review the prior content segment with, e.g., enhanced content. In some embodiments, multiple forms of enhanced content may be included along with playback of the prior scene. In some embodiments, selection of response button 372 may case the system to resume playback of content as, e.g., a next scene or segment. In some embodiments, selecting response buttons 374 and/or 376 may trigger playback of enhanced content along with playback of the prior scene. Selecting response button 372 (e.g., “No Issues”) may still indicate a need to review the prior scene. For instance, if complexity interface 360 was caused by a replay or skip-back control, and response button 372 is selected, the prior scene may be played back with or without enhanced content.

Depicted in complexity interface 360 is enhanced content configuration 370. In scenario 350, enhanced content configuration 370 indicates that “Enhanced Content for future complex scenes will be turned ON with an answer of (1) or (2).” For example, enhanced content may be activated by selecting one or more responses of complexity interface 360 that may indicate complexity, such as response button 374 and/or response button 376. In some embodiments, selecting response button 374 and/or response button 376 may cause user interface 355 to provide enhanced content for future scenes of content with a complexity score that is greater than or equal to a complexity score associated with the scene identified by scene identification 362.

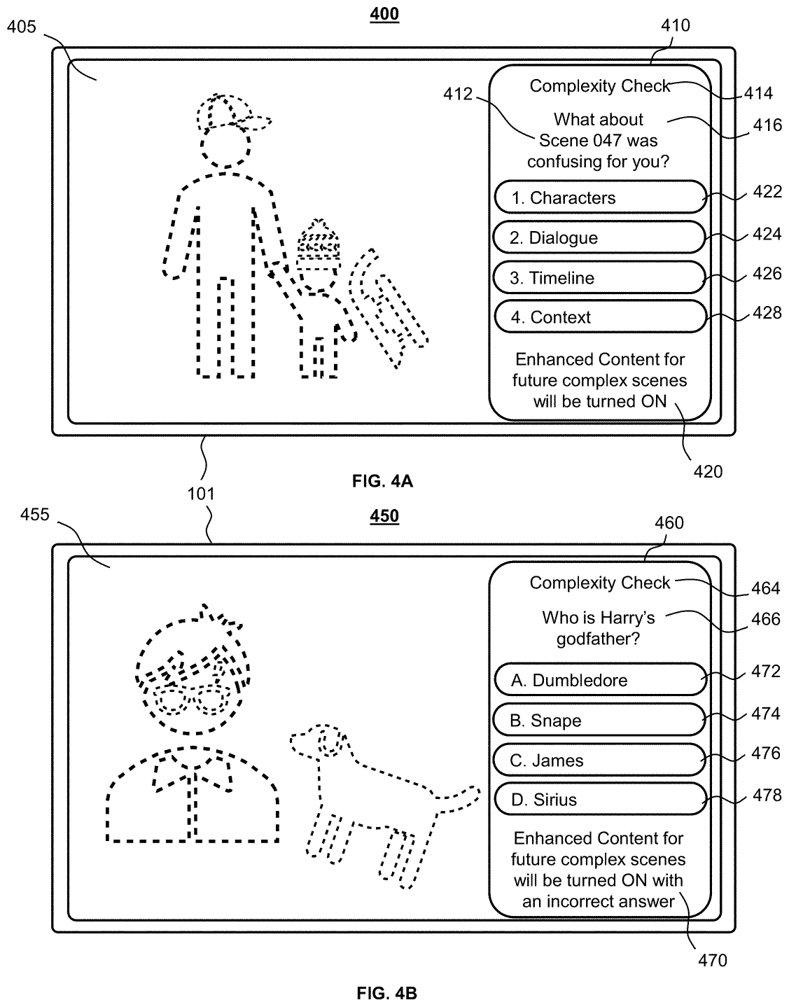

FIG. 4A depicts illustrative scenario 400 and user interface 405 for identifying a complex segment and providing enhanced content, in accordance with some embodiments of the disclosure. Scenario 400 of FIG. 4A illustrates a content delivery system featuring a graphical user interface, e.g., user interface 405, depicting a scene from a program with interactivity regarding how complex the scene may be. As shown, device 101 generates user interface 405.

In scenario 400, user interface 405 includes a depiction of a provided program along with interactivity options. User interface 405 may include an overlay, such as complexity interface 410 as depicted in scenario 400. Appearance of complexity interface 410 may occur as a result of input indicating a scene or segment was complex or needs to be re-watched. For instance, complexity interface 410 may appear as a result of a rewind or replay command. A user may input a “go back 30 seconds” command, and complexity interface 410 may pop up. In some embodiments, complexity interface 410 may appear as a result of input such as a menu request or other remote-control command such as pressing of a replay button or a voice command, indicating lack of comprehension. In some embodiments, complexity interface 410 may appear automatically and/or based on preference settings.

In some embodiments, such as depicted in scenario 400, complexity interface 410 may include a scene identification 412. In scenario 400, for example, scene identification 412 indicates that “Scene 047” is depicted.

In scenario 400, complexity interface 410 includes label 414 and complexity prompt 416. In some embodiments, a complexity interface may announce a “Complexity Check” or ask “What about Scene 047 was confusing for you?” as complexity prompt 416. In scenario 400, complexity prompt 416 is depicted along with several options of complexity issues for selection. For instance, complexity interface 410 may include character issues 422, dialogue issues 424, timeline issues 426, and/or context issues 428. In some embodiments, each button may trigger playback of enhanced content along with playback of the prior scene. For instance, selecting character issues 422 may cause replay of the segment and provide identification of who is involved in the segment and/or who is speaking. In some embodiments, selecting dialogue issues 424 may cause replay of the segment and provide enhanced dialogue and/or closed-captions. In some embodiments, selecting timeline issues 426 may cause replay of another segment and/or re-ordering of scenes in order to depict scenes in chronological order. In some embodiments, selecting context issues 428 may, e.g., cause replay of the segment with background information and/or other descriptions. In some embodiments, several buttons may be selected so that multiple forms of enhanced content may be included along with playback of the prior scene.

Depicted in complexity interface 410 is enhanced content configuration 420. In scenario 400, enhanced content configuration 420 indicates that “Enhanced Content for future complex scenes will be turned ON.” For example, enhanced content may be activated by selecting one or more options of complexity interface 410, such as character issues 422, dialogue issues 424, timeline issues 426, and/or context issues 428, and user interface 405 would provide enhanced content for future scenes of content with a complexity score that is greater than or equal to a complexity score associated with the scene identified by scene identification 412. In some embodiments, enhanced content for future scenes of content above the threshold may be tailored to a particular issue. For instance, selecting character issues 422 may provide enhanced content for future scenes identifying who is involved in the segment and/or who is speaking. In some embodiments, selecting dialogue issues 424 may provide enhanced content for future scenes via enhanced dialogue and/or closed-captions.

In some embodiments, responses to complexity prompt 416, such as selections of character issues 422, dialogue issues 424, timeline issues 426, and/or context issues 428 may cause recordation of the corresponding complexity score, as well as scene identification 412 and other metadata. Complexity score may be recorded in a complexity database and used to calculate complexity scores. In some embodiments, complexity score may be calculated or adjusted based on multiple viewers each selecting character issues 422, dialogue issues 424, timeline issues 426, and/or context issues 428, respectively.

FIG. 4B depicts an illustrative scenario and user interface for identifying a complex segment to provide enhanced content, in accordance with some embodiments of the disclosure.

An exemplary embodiment is depicted in FIG. 4B as scenario 450 with device 101 generating user interface 455. Scenario 450 of FIG. 4B depicts a complexity check in the form of a question and/or quiz. Scenario 450 illustrates an embodiment of a content delivery system featuring a graphical user interface, e.g., user interface 455, produced by device 101, depicting a scene from a program with interactivity regarding how complex the scene may be. User interface 455 of scenario 450 may be provided to, e.g., specific users, random users, or all users, so that a complexity engine may solicit and receive data regarding complexity of various content segments. A complexity engine may record results of solicitation, such as depicted in scenario 450, so as to generate and/or adjust complexity scores for content segments.

Scenario 450, for example, asks a question about the content to solicit feedback as to whether a scene is complex or not complex, in order to tag a scene and collect data regarding scene complexity. In scenario 450, user interface 455 includes a depiction of a provided program along with interactivity options. User interface 455 may include an overlay, such as complexity interface 460 as depicted in scenario 450. In scenario 450, complexity interface 460 appears in user interface 455 after a content segment was provided to request feedback regarding complexity.

Appearance of complexity interface 460 may occur automatically or as a result of input indicating a scene or segment was complex or needs to be re-watched. For instance, complexity interface 460 may appear as a result of other users indicating the segment was complex. In some embodiments, other users, e.g., connected via social networking, may provide questions. In some embodiments, complexity interface 460 may appear as a result of input such as a menu request or other remote-control command such as pressing of a replay button or a voice command, indicating lack of comprehension. In some embodiments, complexity interface 460 may appear automatically and/or based on preference settings. For instance, complexity interface 460 may appear to request feedback about a particular content segment because the content segment may be new and/or lack sufficient data for a complexity engine to determine a complexity score.

In scenario 450, complexity interface 460 includes label 464 and prompt 466. In some embodiments, a complexity interface may announce a “Complexity Check” and/or ask a question about the content. In scenario 450, complexity question prompt 466 is depicted along with several options available for selection. Complexity question prompt 466 of scenario 450, for example, solicits feedback as to whether a scene is complex or not complex, in order to tag a scene and collect data. In some embodiments, complexity question prompt 466 may ask a trivia question to determine comprehension. For instance, complexity question prompt 466 asks “Who is Harry's godfather?” In scenario 450, the prior segment may have revealed that Harry's godfather is Sirius, and this question may test comprehension of that scene. Complexity interface 460 may include answer options such as response buttons 472, 474, 476, and/or 478. For instance, scenario 450 includes complexity question prompt 466 asking “Who is Harry's godfather?” and offers responses as response button 472 (“A. Dumbledore”), response button 474 (“B. Snape”), response button 476 (“C. James”), and response button 478 (“D. Sirius”).

In some embodiments, response options may be different. For instance, response buttons 472, 474, 476, and/or 478 may be expanded or contracted to more or fewer choices, respectively. In some embodiments, question response options may include a numeric scale of 0 to 99. In some embodiments, response options may include voice or audio feedback.

In some embodiments, responses to complexity question prompt 466, such as selection of any of response buttons 472, 474, 476, and/or 478, may be recorded in a complexity database and used to calculate complexity scores. Complexity scores may be calculated using various statistical analyses. Complexity scores associated with the content segment may be adjusted based on recorded responses of correct or incorrect answers. Complexity scores associated with other content segments may be adjusted based on correct or incorrect answers of other users, e.g., connected via social network.

In some embodiments, selecting an incorrect answer to complexity question prompt 466 may trigger playback of enhanced content along with playback of the prior scene. In some embodiments, multiple forms of enhanced content may be included along with playback of the prior scene. In some embodiments, a correct selection of response button 478 may resume to a next scene or segment. In some embodiments, selecting response button 472, 474, or 476 may trigger playback of enhanced content along with playback of the prior scene, because selecting response button 472, 474, or 476 may indicate a lack of understanding and/or a need to review the prior content segment with, e.g., enhanced content. Different responses may indicate different degrees of comprehension (or misunderstanding). For instance, selecting response button 476 (“C. James”) may indicate an issue with dialogue and initiate enhanced content to clarify dialogue or provide captions. Selecting response button 474 (“B. Snape”) may indicate an issue with picture and initiate enhanced content to brighten or clarify video. Selecting correct response button 478 does not necessarily indicate no need to review with enhanced content. For instance, if complexity interface 460 was caused by a replay or skip-back control, and response button 478 is selected, the prior scene may be played back with or without enhanced content.

Depicted in complexity interface 460 is enhanced content configuration 470. In scenario 450, enhanced content configuration 470 indicates that “Enhanced Content for future complex scenes will be turned ON with an incorrect answer.” For example, enhanced content may be activated by selecting one or more incorrect responses of complexity interface 460, which may indicate complexity. In some embodiments, selecting incorrect response button 472, response button 474 and/or response button 476 may cause user interface 455 to provide enhanced content for future scenes of content with complexity scores greater than or equal to a complexity score associated with the scene.

In some embodiments, responses to complexity question prompt 466, such as selections of response buttons 472, 474, 476, and/or 478 may cause recordation of the corresponding complexity score, as well as scene identification data and other metadata. Complexity score may be recorded in a complexity database and used to calculate complexity scores. In some embodiments, complexity score may be calculated or adjusted based on multiple viewers each selecting response buttons 472, 474, 476, and/or 478, respectively.

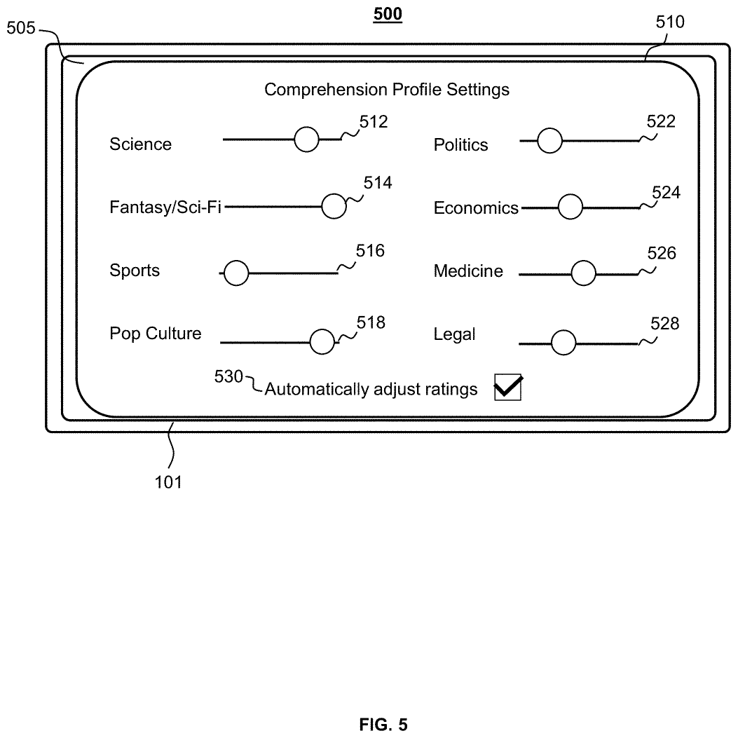

FIG. 5 depicts an illustrative scenario and user interface for a profile based on complex segments and enhanced content, in accordance with some embodiments of the disclosure.

An exemplary embodiment is depicted in FIG. 5 as scenario 500 with device 101 generating user interface 505. Scenario 500 of FIG. 5 illustrates an embodiment of a content delivery system featuring a graphical user interface, e.g., user interface 505, produced by device 101, depicting an interactive interface regarding comprehension and/or perceived complexity.

In scenario 500, user interface 505 includes a depiction of a comprehension profile including several genres of content. Content may be associated with metadata to identify one or more genres associated with the content. User interface 505 may include an overlay, such as profile interface 510 as depicted in scenario 500. Appearance of profile interface 510 may occur as a result of input indicating a request for a profile or settings menu. In some embodiments, profile interface 510 may appear automatically and/or based on changes in preference settings.

In some embodiments, such as depicted in scenario 500, profile interface 510 may include a plurality of genres and a rating for each genre. For instance, each genre depicted in profile interface 510 is associated with a slider bar representing a rating. In some embodiments, a slider bar may be a scale, such as a score from 0 to 5.0. A proportional scale, such as 0 to 1.0 or 0 to 99 might be used. In some embodiments, a slider bar may be an absolute scale. In some embodiments, a slider bar may only be in comparison to other genres.

In scenario 500, genres 512, 514, 516, 518, 522, 524, 526, and 528 each have different slider bar positions indicating different comprehension values. For instance, genre 514, indicating “Fantasy/Sci-Fi,” depicts a maximum rating, e.g., 5.0 out of 5.0, while genre 516, indicating “Sports,” depicts a very low rating, e.g., 0.5 out of 5.0.

In some embodiments, a slider bar may be manipulated to reflect a user's preferences. In some embodiments, a slider bar may not be adjustable such as when each genre rating is calculated automatically. For instance, in scenario 500, checkbox 530 is checked to indicate that the complexity engine will automatically adjust ratings. In situations where ratings are automatically adjusted based on, e.g., requests to re-watch segments and/or responses to complexity checks, allowing adjustment of genre ratings may be limited. In some embodiments, setting initial ratings may be allowed and thereafter ratings may be automatically calculated.

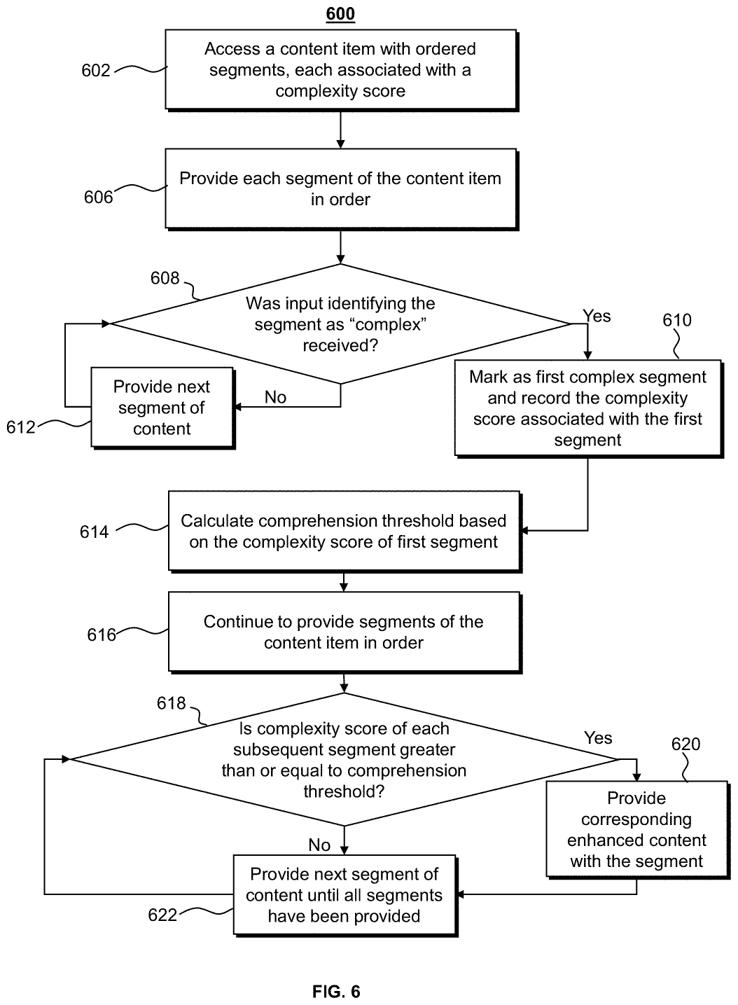

FIG. 6 depicts an illustrative flowchart of a process for identifying a complex segment to provide enhanced content, in accordance with some embodiments of the disclosure. Some embodiments may include, for instance, a complexity engine, e.g., as part of an interactive content guidance application, carrying out the steps of process 600 depicted in the flowchart of FIG. 6. In some embodiments, results of process 600 may be recorded in a complexity profile.

At step 602, a complexity engine accesses a content item. In some embodiments, such as process 600, a content item includes ordered segments of content, with each segment associated with a complexity score. In some embodiments, a complexity score for each segment must be retrieved from, e.g., and complexity database.

At step 606, the complexity engine provides each segment of the content item. In some embodiments, such as process 600, each segment is provided in order. In some embodiments, playback of a content item may re-order or skip segments based on, e.g., complexity scores or other metadata.

At step 608, as each segment is provided, the complexity engine determines if there is input identifying a segment as “complex.” In some embodiments, input such as a menu request or other remote-control command. For instance, input may be received as voice or via remote control signal. Such input may be, for example, selecting a menu button, answering a prompt, or requesting a scene to be replayed. For instance, input may be a rewind or replay command. A device may receive a “go back 30 seconds” command. A user may input a directional arrow command to identify complexity. A user may input a pause command to identify complexity. In some embodiments, a voice command may indicate confusion or a lack of understanding. For instance, a viewer may say, “I didn't understand that scene,” “That was confusing,” or “What happened?” In some embodiments, input may be a lack of input, such as allowing a timer to expire.

At step 612, if there is no input identifying a segment as “complex” is received, then the complexity engine provides the next segment of the content item.

At step 610, if input, e.g., from a remote control, identifying a segment as “complex” received, then the complexity engine marks the segment as an identified complex segment. In process 600, the complexity score corresponding to the identified complex segment is recorded. In some embodiments, a complexity score for the first complex segment may be recorded in a database or profile, e.g., a complexity database.

At step 614, the complexity engine calculates a comprehension threshold based on the complexity score of first complex segment. In process 600, the complexity score corresponding to the identified complex segment is recorded as the comprehension threshold. In some embodiments, the complexity score corresponding to the identified complex segment may be increased a percentage, e.g., 5% and recorded as the comprehension threshold. In some embodiments, the complexity score corresponding to the identified complex segment may be decreased by a percentage, e.g., 10% and recorded as the comprehension threshold. In some embodiments, a complexity score may be increased or decreased based on the segment number. In some embodiments, a complexity score may be increased or decreased based on a prior calculation based on a complexity profile.

At step 616, the complexity engine resumes providing each segment of the content item. In process 600, each segment continues to be provided in order. In some embodiments, playback of a content item may re-order or skip segments based on, e.g., complexity scores or other metadata.

At step 618, as each segment is provided, the complexity engine determines if the corresponding complexity score of each segment is greater than or equal to the comprehension threshold. In some embodiments, the complexity engine may determine if the corresponding complexity score of each segment exceeds the comprehension threshold.

If the complexity engine determines, at step 618, the corresponding complexity score of a segment is greater than or equal to the comprehension threshold then, at step 620, the complexity engine provides, with the segment, enhanced content corresponding to the segment. Once the segment has been provided, the complexity engine provides the next segment of the content item at step 622, until all of the segments of the content item have been provided.

However, if the complexity engine determines, at step 618, the corresponding complexity score of a segment is less than the comprehension threshold then, at step 622, the complexity engine provides the next segment of the content item, until all of the segments of the content item have been provided.

FIG. 7 shows a generalized embodiment of illustrative device 700. As referred to herein, device 700 should be understood to mean any device that can receive input from one or more other devices, one or more network-connected devices, one or more electronic devices having a display, or any device that can provide content for consumption. As depicted in FIG. 7, device 700 is a smartphone, however, device 700 is not limited to smartphones and/or may be any computing device. For example, device 700 of FIG. 7 can be in system 800 of FIG. 8 as device 802, including but not limited to a smartphone, a smart television, a tablet, a microphone (e.g., with voice control or a virtual assistant), a computer, or any combination thereof, for example.

Device 700 may be implemented by a device or system, e.g., a device providing a display to a user, or any other suitable control circuitry configured to generate a display to a user of content. For example, device 700 of FIG. 7 can be implemented as equipment 701. In some embodiments, equipment 701 may include set-top box 716 that includes, or is communicatively coupled to, display 712, audio equipment 714, and user input interface 710. In some embodiments, display 712 may include a television display or a computer display. In some embodiments, user interface input 710 is a remote-control device. Set-top box 716 may include one or more circuit boards. In some embodiments, the one or more circuit boards include processing circuitry, control circuitry, and storage (e.g., RAM, ROM, Hard Disk, Removable Disk, etc.). In some embodiments, circuit boards include an input/output path. Each one of device 700 and equipment 701 may receive content and receive data via input/output (hereinafter “I/O”) path 702. I/O path 702 may provide content and receive data to control circuitry 704, which includes processing circuitry 706 and storage 708. Control circuitry 704 may be used to send and receive commands, requests, and other suitable data using I/O path 702. I/O path 702 may connect control circuitry 704 (and specifically processing circuitry 706) to one or more communication paths (described below). I/O functions may be provided by one or more of these communication paths but are shown as a single path in FIG. 7 to avoid overcomplicating the drawing. While set-top box 716 is shown in FIG. 7 for illustration, any suitable computing device having processing circuitry, control circuitry, and storage may be used in accordance with the present disclosure. For example, set-top box 716 may be replaced by, or complemented by, a personal computer (e.g., a notebook, a laptop, a desktop), a smartphone (e.g., device 700), a tablet, a network-based server hosting a user-accessible client device, a non-user-owned device, any other suitable device, or any combination thereof.

Control circuitry 704 may be based on any suitable processing circuitry such as processing circuitry 706. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 704 executes instructions for an application complexity engine stored in memory (e.g., storage 708). Specifically, control circuitry 704 may be instructed by the application to perform the functions discussed above and below. For example, the application may provide instructions to control circuitry 704 to generate the content guidance displays. In some implementations, any action performed by control circuitry 704 may be based on instructions received from the application.

In some client/server-based embodiments, control circuitry 704 includes communications circuitry suitable for communicating with an application server. A complexity engine may be a stand-alone application implemented on a device or a server. A complexity engine may be implemented as software or a set of executable instructions. The instructions for performing any of the embodiments discussed herein of the complexity engine may be encoded on non-transitory computer-readable media (e.g., a hard drive, random-access memory on a DRAM integrated circuit, read-only memory on a BLU-RAY disk, etc.) or transitory computer-readable media (e.g., propagating signals carrying data and/or instructions). For example, in FIG. 7, the instructions may be stored in storage 708, and executed by control circuitry 704 of a device 700.

In some embodiments, a complexity engine may be a client/server application where only the client application resides on device 700 (e.g., device 802), and a server application resides on an external server (e.g., server 806). For example, a complexity engine may be implemented partially as a client application on control circuitry 704 of device 700 and partially on server 806 as a server application running on control circuitry. Server 806 may be a part of a local area network with device 802 or may be part of a cloud computing environment accessed via the internet. In a cloud computing environment, various types of computing services for performing searches on the internet or informational databases, providing storage (e.g., for the keyword-topic database) or parsing data are provided by a collection of network-accessible computing and storage resources (e.g., server 806), referred to as “the cloud.” Device 700 may be a cloud client that relies on the cloud computing capabilities from server 806 to determine times, identify one or more content items, and provide content items by the complexity engine. When executed by control circuitry of server 806, the complexity engine may instruct the control circuitry to generate the complexity engine output (e.g., content items and/or indicators) and transmit the generated output to device 802. The client application may instruct control circuitry of the receiving device 802 to generate the complexity engine output. Alternatively, device 802 may perform all computations locally via control circuitry 704 without relying on server 806.

Control circuitry 704 may include communications circuitry suitable for communicating with a complexity engine server, a quotation database server, or other networks or servers. The instructions for carrying out the above-mentioned functionality may be stored and executed on the application server 806. Communications circuitry may include a cable modem, an integrated-services digital network (ISDN) modem, a digital subscriber line (DSL) modem, a telephone modem, an ethernet card, or a wireless modem for communications with other equipment, or any other suitable communications circuitry. Such communications may involve the internet or any other suitable communication network or paths. In addition, communications circuitry may include circuitry that enables peer-to-peer communication of devices, or communication of devices in locations remote from each other.

Memory may be an electronic storage device such as storage 708 that is part of control circuitry 704. As referred to herein, the phrase “electronic storage device” or “storage device” should be understood to mean any device for storing electronic data, computer software, or firmware, such as random-access memory, read-only memory, hard drives, optical drives, solid state devices, quantum storage devices, gaming consoles, gaming media, or any other suitable fixed or removable storage devices, and/or any combination of the same. Storage 708 may be used to store various types of content described herein as well as content guidance data described above. Nonvolatile memory may also be used (e.g., to launch a boot-up routine and other instructions). Cloud-based storage, for example, (e.g., on server 806) may be used to supplement storage 708 or instead of storage 708.

A user may send instructions to control circuitry 704 using user input interface 710. User input interface 710, display 712 may be any suitable interface such as a touchscreen, touchpad, or stylus and/or may be responsive to external device add-ons, such as a remote control, mouse, trackball, keypad, keyboard, joystick, voice recognition interface, or other user input interfaces. Display 710 may include a touchscreen configured to provide a display and receive haptic input. For example, the touchscreen may be configured to receive haptic input from a finger, a stylus, or both. In some embodiments, equipment device 700 may include a front-facing screen and a rear-facing screen, multiple front screens, or multiple angled screens. In some embodiments, user input interface 710 includes a remote-control device having one or more microphones, buttons, keypads, any other components configured to receive user input or combinations thereof. For example, user input interface 710 may include a handheld remote-control device having an alphanumeric keypad and option buttons. In a further example, user input interface 710 may include a handheld remote-control device having a microphone and control circuitry configured to receive and identify voice commands and transmit information to set-top box 716.

Audio equipment 710 may be integrated with or combined with display 712. Display 712 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 712. Speakers 714 may be provided as integrated with other elements of each one of device 700 and equipment 701 or may be stand-alone units. An audio component of videos and other content displayed on display 712 may be played through speakers of audio equipment 714. In some embodiments, audio may be distributed to a receiver (not shown), which processes and outputs the audio via speakers of audio equipment 714. In some embodiments, for example, control circuitry 704 is configured to provide audio cues to a user, or other audio feedback to a user, using speakers of audio equipment 714. Audio equipment 714 may include a microphone configured to receive audio input such as voice commands or speech. For example, a user may speak letters or words that are received by the microphone and converted to text by control circuitry 704. In a further example, a user may voice commands that are received by a microphone and recognized by control circuitry 704.

An application (e.g., for generating a display) may be implemented using any suitable architecture. For example, a stand-alone application may be wholly implemented on each one of device 700 and equipment 701. In some such embodiments, instructions of the application are stored locally (e.g., in storage 708), and data for use by the application is downloaded on a periodic basis (e.g., from an out-of-band feed, from an Internet resource, or using another suitable approach). Control circuitry 704 may retrieve instructions of the application from storage 708 and process the instructions to generate any of the displays discussed herein. Based on the processed instructions, control circuitry 704 may determine what action to perform when input is received from input interface 710. For example, movement of a cursor on a display up/down may be indicated by the processed instructions when input interface 710 indicates that an up/down button was selected. An application and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 704 may allow a user to provide user profile information or may automatically compile user profile information. For example, control circuitry 704 may monitor the words the user inputs in his/her messages for keywords and topics. In some embodiments, control circuitry 704 monitors user inputs such as texts, calls, conversation audio, social media posts, etc., to detect keywords and topics. Control circuitry 704 may store the detected input terms in a keyword-topic database and the keyword-topic database may be linked to the user profile. Additionally, control circuitry 704 may obtain all or part of other user profiles that are related to a particular user (e.g., via social media networks), and/or obtain information about the user from other sources that control circuitry 704 may access. As a result, a user can be provided with a unified experience across the user's different devices.

In some embodiments, the application is a client/server-based application. Data for use by a thick or thin client implemented on each one of device 700 and equipment 701 is retrieved on-demand by issuing requests to a server remote from each one of device 700 and equipment 701. For example, the remote server may store the instructions for the application in a storage device. The remote server may process the stored instructions using circuitry (e.g., control circuitry 704) and generate the displays discussed above and below. The client device may receive the displays generated by the remote server and may display the content of the displays locally on device 700. This way, the processing of the instructions is performed remotely by the server while the resulting displays (e.g., that may include text, a keyboard, or other visuals) are provided locally on device 700. Device 700 may receive inputs from the user via input interface 710 and transmit those inputs to the remote server for processing and generating the corresponding displays. For example, device 700 may transmit a communication to the remote server indicating that an up/down button was selected via input interface 710. The remote server may process instructions in accordance with that input and generate a display of the application corresponding to the input (e.g., a display that moves a cursor up/down). The generated display is then transmitted to device 700 for presentation to the user.

As depicted in FIG. 8, device 802 may be coupled to communication network 804. Communication network 804 may be one or more networks including the internet, a mobile phone network, mobile voice or data network (e.g., a 4G or LTE network), cable network, public switched telephone network, Bluetooth, or other types of communication network or combinations of communication networks. Thus, device 802 may communicate with server 806 over communication network 804 via communications circuitry described above. In should be noted that there may be more than one server 806, but only one is shown in FIG. 8 to avoid overcomplicating the drawing. The arrows connecting the respective device(s) and server(s) represent communication paths, which may include a satellite path, a fiber-optic path, a cable path, a path that supports internet communications (e.g., IPTV), free-space connections (e.g., for broadcast or other wireless signals), or any other suitable wired or wireless communications path or combination of such paths.

In some embodiments, the application is downloaded and interpreted or otherwise run by an interpreter or virtual machine (e.g., run by control circuitry 704). In some embodiments, the application may be encoded in the ETV Binary Interchange Format (EBIF), received by control circuitry 704 as part of a suitable feed, and interpreted by a user agent running on control circuitry 704. For example, the application may be an EBIF application. In some embodiments, the application may be defined by a series of JAVA-based files that are received and run by a local virtual machine or other suitable middleware executed by control circuitry 704.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method of identifying complex segments in content and providing enhanced content with subsequent complex segments, the method comprising:
accessing content, the content including a plurality of ordered segments and each of the plurality of ordered segments associated with a complexity score;
providing for consumption each of the plurality of ordered segments of the content;
receiving input identifying a first segment of the plurality of ordered segments as complex;
calculating a comprehension threshold based on the complexity score associated with the first segment;
identifying a second segment of the plurality of ordered segments with an associated complexity score greater than or equal to the comprehension threshold, the second segment provided subsequent to providing the first segment of the plurality of ordered segments;
in response to identifying the second segment, accessing additional enhanced content to be displayed contemporaneously with the second segment; and
providing the second segment with the enhanced content for contemporaneous display.

2. The method of claim 1, wherein each complexity score associated with each of the plurality of ordered segments is based on input from a plurality of users.

3. The method of claim 2, wherein the plurality of users are each connected via a social network.

4. The method of claim 1, wherein the comprehension threshold is associated with a genre corresponding to the content.

5. The method of claim 1, wherein enhanced content includes alterations to the order of the plurality of ordered segments of the content.

6. The method of claim 1, wherein enhanced content includes closed caption information.

7. The method of claim 1, wherein enhanced content includes additional dialogue information.

8. The method of claim 1, wherein enhanced content includes additional content.

9. The method of claim 1, wherein enhanced content includes text description.

10. The method of claim 1, wherein the input includes a rewind or replay command.

11. A system for identifying complex segments in content and providing enhanced content with subsequent complex segments, the system comprising:
input/output circuitry configured to receive input identifying as complex a first segment of a plurality of ordered segments of content, each of the plurality of ordered segments associated with a complexity score;
processing circuitry configured to access the content, provide for consumption each of the plurality of ordered segments of the content,
second processing circuitry configured to calculate a comprehension threshold based on the complexity score associated with the first segment, identify a second segment of Reply to Final Office Action of Oct. 27, 2020 the plurality of ordered segments with an associated complexity score greater than or equal to the comprehension threshold, the second segment provided subsequent to providing the first segment of the plurality of ordered segments, access additional enhanced content to be displayed contemporaneously with the second segment in response to identifying the second segment, and provide the second segment with the enhanced content for contemporaneous display.

12. The system of claim 11, wherein each complexity score associated with each of the plurality of ordered segments is based on input from a plurality of users.

13. The system of claim 12, wherein the plurality of users are each connected via a social network.

14. The system of claim 11, wherein the comprehension threshold is associated with a genre corresponding to the content.

15. The system of claim 11, wherein enhanced content includes information describing alterations to the order of the plurality of ordered segments of the content.

16. The system of claim 11, wherein enhanced content includes closed caption information.

17. The system of claim 11, wherein enhanced content includes additional dialogue information.

18. The system of claim 11, wherein enhanced content includes additional content.

19. The system of claim 11, wherein enhanced content includes text description.

20. (canceled)

21. A non-transitory computer-readable medium having instructions encoded thereon that when executed by control circuitry cause the control circuitry to:
access content, the content including a plurality of ordered segments and each of the plurality of ordered segments associated with a complexity score;
provide for consumption each of the plurality of ordered segments of the content;
receive input identifying a first segment of the plurality of ordered segments as complex;
calculate a comprehension threshold based on the complexity score associated with the first segment;
identify a second segment of the plurality of ordered segments with an associated complexity score greater than or equal to the comprehension threshold, the second segment provided subsequent to providing the first segment of the plurality of ordered segments;
in response to identifying the second segment, access additional enhanced content to be displayed contemporaneously with the second segment; and
provide the second segment with the enhanced content for contemporaneous display.

22-30. (canceled)
